(19) United States
(12) Patent Application Publication
(10) Pub. No.: US 2026/0087831 A1
(43) Pub. Date: Mar. 26, 2026

(54) ANALYSIS DEVICE, ANALYSIS SYSTEM, ANALYSIS METHOD, AND NON-TRANSITORY COMPUTER-READABLE MEDIUM

(71) Applicant: NEC Corporation, Tokyo (JP)

(72) Inventors: Yoshimasa Ono, Tokyo (JP); Toshiyuki Nomura, Tokyo (JP); Junichi Abe, Tokyo (JP); Hidemi Noguchi, Tokyo (JP); Tatsuya Fujimoto, Tokyo (JP)

(73) Assignee: NEC Corporation, Tokyo (JP)

(21) Appl. No.: 19/321,677

(22) Filed: Sep. 8, 2025

(30) Foreign Application Priority Data
Sep. 25, 2024 (JP) 2024-165919

(51) Int. Cl. G06V 20/64; G06T 7/215; G06V 20/54

(52) U.S. Cl. CPC G06V 20/64; G06T 7/215; G06V 20/54; G06T 2207/10028; G06V 2201/08

(57) ABSTRACT

An analysis device according to the present disclosure includes a detection unit for detecting at least one moving object included in evaluation point cloud data by using a difference between reference point cloud data indicating a predetermined space in a reference period and the evaluation point cloud data indicating the predetermined space in an evaluation period, a recognition unit for recognizing at least one object included in image data of the predetermined space, a processing unit for associating the at least one object with the at least one moving object, and an attribute assignment unit for assigning an attribute of the object to the moving object associated with the object.

### INCORPORATION BY REFERENCE

This application is based upon and claims the benefit of priority from Japanese patent application No. 2024-165919, filed on Sep. 25, 2024, the disclosure of which is incorporated herein in its entirety by reference.

### TECHNICAL FIELD

The present disclosure relates to an analysis device, an analysis system, an analysis method, and a program.

### BACKGROUND ART

In order to achieve automatic driving of a vehicle, a traffic control system that utilizes information detected by a sensor installed on a road side has been studied. As travel assistance achieved by the traffic control system, it has been studied to recognize a moving object such as a vehicle traveling on a road or a person walking, and notifying information related to the moving object to a mobile terminal or the like held by the vehicle or the person.

JP 7424535 B1 discloses a configuration of a device for detecting a position of a vehicle from three-dimensional point cloud data measured by a measurement device using Light Detection And Ranging (LiDAR). Specifically, JP 7424535 B1 discloses detecting a position of a vehicle by inputting three-dimensional point cloud data to a trained model and executing object detection.

### SUMMARY

The device disclosed in JP 7424535 B1 executes object detection using three-dimensional point cloud data. However, it is generally known that object detection processing using three-dimensional point cloud data has a high processing load. Therefore, there is a problem that it is difficult to perform object detection using three-dimensional point cloud data in a traffic control system that provides information to a mobile terminal held by a vehicle or a person in real time.

An example object of the present disclosure is to provide an analysis device, an analysis system, an analysis method, and a program capable of suppressing a load of recognition processing of an object included in three-dimensional point cloud data.

An analysis device according to an example aspect of the present disclosure includes a detection unit for detecting at least one moving object included in evaluation point cloud data by using a difference between reference point cloud data indicating a predetermined space in a reference period and the evaluation point cloud data indicating the predetermined space in an evaluation period, a recognition unit for recognizing at least one object included in image data of the predetermined space, a processing unit for associating the at least one object with the at least one moving object, and an attribute assignment unit for assigning an attribute of the object to the moving object associated with the object.

An analysis system according to an example aspect of the present disclosure includes a first sensor for generating reference point cloud data indicating a predetermined space in a reference period and evaluation point cloud data indicating the predetermined space in an evaluation period, a second sensor for generating image data of the predetermined space, and an analysis device including a detection unit for detecting at least one moving object included in the evaluation point cloud data by using a difference between the reference point cloud data and the evaluation point cloud data, a recognition unit for recognizing at least one object included in the image data of the predetermined space, a processing unit for associating the at least one object with the at least one moving object, and an attribute assignment unit for assigning an attribute of the object to the moving object associated with the object.

An analysis method according to an example aspect of the present disclosure includes detecting at least one moving object included in evaluation point cloud data by using a difference between reference point cloud data indicating a predetermined space in a reference period and the evaluation point cloud data indicating the predetermined space in an evaluation period, recognizing at least one object included in image data of the predetermined space, associating the at least one object with the at least one moving object, and assigning an attribute of the object to the moving object associated with the object.

A program according to an example aspect of the present disclosure causes a computer to execute detecting at least one moving object included in evaluation point cloud data by using a difference between reference point cloud data indicating a predetermined space in a reference period and the evaluation point cloud data indicating the predetermined space in an evaluation period, recognizing at least one object included in image data of the predetermined space, associating the at least one object with the at least one moving object, and assigning an attribute of the object to the moving object associated with the object.

According to the present disclosure, an analysis device, an analysis system, an analysis method, and a program capable of suppressing a load of recognition processing of an object included in three-dimensional point cloud data can be provided.

### BRIEF DESCRIPTION OF DRAWINGS

FIG. 1 illustrates a configuration example of an analysis device;

FIG. 2 illustrates a flow of analysis processing executed in the analysis device;

FIG. 3 illustrates a configuration example of an analysis system;

FIG. 4 illustrates three-dimensional point cloud data generated in a reference period;

FIG. 5 illustrates three-dimensional point cloud data generated in an evaluation period;

FIG. 6 illustrates image data;

FIG. 7 illustrates a flow of processing related to three-dimensional point cloud data executed by the analysis device;

FIG. 8 illustrates a flow of processing related to image data executed in the analysis device;

FIG. 9 illustrates calculation processing of the speed of an object executed in the analysis device;

FIG. 10 illustrates a flow of image recognition processing of image data regarding a region of interest; and

FIG. 11 is a block diagram illustrating a configuration example of the analysis devices 10 and 20.

### EXAMPLE EMBODIMENT

### First Example Embodiment

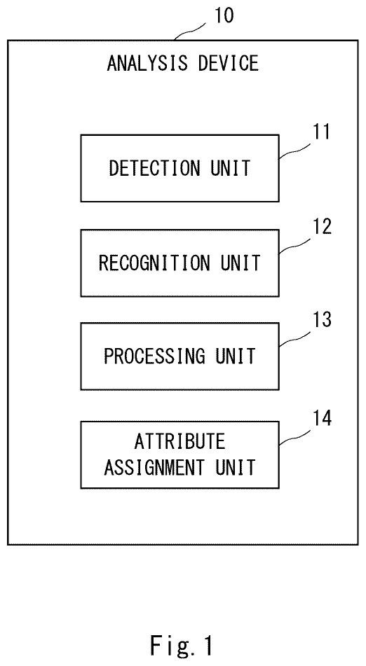

A configuration example of the analysis device 10 will be described with reference to FIG. 1. The analysis device 10 may be a computer device that operates in a case where a processor executes a program stored in a memory.

The analysis device 10 includes a detection unit 11, a recognition unit 12, a processing unit 13, and an attribute assignment unit 14. The detection unit 11, the recognition unit 12, the processing unit 13, and the attribute assignment unit 14 may be software or a module in which processing is executed by a processor executing a program stored in a memory. Alternatively, the detection unit 11, the recognition unit 12, the processing unit 13, and the attribute assignment unit 14 may be hardware such as a circuit or a chip. The detection unit 11, the recognition unit 12, the processing unit 13, and the attribute assignment unit 14 may constitute an analysis system by being distributed and arranged in a plurality of devices. In addition, the analysis device 10 or the analysis system may provide a function executed by each component to a user who uses the analysis device 10 or the analysis system by using a form of cloud computing. A function executed by each component may be referred to as a service.

The detection unit 11 may be used as a means for detecting data. The recognition unit 12 may be used as a means for recognizing data. The processing unit 13 may be used as a means for processing data. The attribute assignment unit 14 may be used as a means for assigning an attribute to data.

The detection unit 11 detects at least one moving object included in evaluation point cloud data by using a difference between reference point cloud data indicating a predetermined space in a reference period and evaluation point cloud data indicating the predetermined space in an evaluation period.

The reference period is a period used to generate the reference point cloud data. The reference point cloud data is point cloud data used as a reference for detecting a moving object in a predetermined space. Furthermore, the reference point cloud data may be point cloud data indicating a space serving as a background before a moving object is included. The reference point cloud data may be referred to as reference point cloud data, background point cloud data, or the like.

The predetermined space may be a space to be monitored or measured. The predetermined space may be a closed space partitioned by a wall or the like in a building, a factory, or the like, or may be an open space outside a building or the like.

The point cloud data is a set of points having three-dimensional information. The three-dimensional information may be coordinates on an X axis, a Y axis, and a Z axis representing a three-dimensional space. The point cloud data may be generated using a sensor. The point cloud data may be generated by a three-dimensional laser scanner or a sensor using LiDAR. Alternatively, the point cloud data may be generated by matching feature points of a plurality of pieces of image data obtained by photographing the same object from a plurality of places. The generation of the point cloud data using the plurality of pieces of image data may be performed using, for example, Structure from Motion (SfM). The image data may be generated by an image capturing apparatus used as a sensor.

The reference period may be, for example, a period in which there is no moving object in the predetermined space, a period in which there are few moving objects, or the like. Few moving objects may mean being fewer than the predetermined number of objects. Alternatively, the reference period may be a period in a predetermined time zone such as nighttime or daytime.

The evaluation period may be a period for determining whether the moving object exists in the predetermined space. The evaluation period may be paraphrased as an observation period or a measurement period for determining whether the moving object exists in the predetermined space. The evaluation point cloud data may be data indicating a space substantially the same as the space indicated by the reference point cloud data. For example, the evaluation point cloud data may be generated using a device installed at the same position as the device that has generated the reference point cloud data and having the same posture. The device may be a three-dimensional laser scanner, a sensor using LiDAR, or the like.

The difference between the reference point cloud data and the evaluation point cloud data may be point cloud data remaining after points included in the reference point cloud data are deleted from the evaluation point cloud data. Since the data indicating the difference is point cloud data that does not exist in the reference point cloud data, the data is estimated as a moving object that newly appeared in the space in the evaluation period. The moving object may be, for example, a vehicle, a person, or the like.

The recognition unit 12 recognizes at least one object included in image data of the predetermined space. The image data may be, for example, data generated by an image capturing apparatus that is a sensor. The image data may be, for example, still image data or moving image data.

Recognizing an object included in image data may be executing image recognition processing. The image recognition processing may specify an attribute, a type, a name, and the like of an object included in the image data. The type, name, and the like of the object may be collectively referred to as an attribute of the object. Furthermore, the image recognition processing may be specifying the face of the person included in the image data. Moreover, the image recognition processing may be specifying the position of the object included in the image data in the space. The image recognition processing may be, for example, recognizing a specific object by comparing image data of the specific object prepared in advance with image data indicating a predetermined space.

Alternatively, the image recognition processing may be processing utilizing Artificial Intelligence (AI). For example, the image recognition processing may be to recognize an object included in the image data by performing deep learning using a neural network. Specifically, in order to optimize parameters used in the neural network, a learning model in which image data and information indicating an attribute, a type, and a name of an object included in the image data are learned as teacher data, learning data, or training data may be generated. The image recognition processing may be outputting an attribute or the like of an object included in the image data by inputting the image data to the generated learning model.

In addition, semantic segmentation may be executed as image recognition processing utilizing AI. Semantic segmentation is, for example, a method of assigning a label indicating an attribute for each pixel of an image.

The processing unit 13 associates at least one object included in the image data with at least one moving object included in the evaluation point cloud data. For example, the processing unit 13 specifies a moving object included in the evaluation point cloud data corresponding to an object included in the image data. For example, the processing unit 13 associates the object included in the image data with the moving object included in the evaluation point cloud data based on the size of a region where a region indicating the object included in the image data and a region indicating the moving object included in the evaluation point cloud data overlap with each other.

In a case where the difference between the position of the moving object included in the evaluation point cloud data and the position of the object included in the image data is smaller than a predetermined value, the processing unit 13 may assume that the object included in the evaluation point cloud data is associated with the object included in the image data. Alternatively, in a case where the difference between the size of the moving object included in the evaluation point cloud data and the size of the object included in the image data is smaller than a predetermined value, the processing unit 13 may assume that the moving object included in the evaluation point cloud data is associated with the object included in the image data. Alternatively, in a case where the difference between the feature amount of the moving object included in the evaluation point cloud data and the feature amount of the object included in the image data is smaller than a predetermined value, the processing unit 13 may assume that the moving object included in the evaluation point cloud data is associated with the object included in the image data.

The attribute assignment unit 14 assigns the attribute of the object included in the image data to the moving object included in the evaluation point cloud data associated with the object included in the image data. The attribute of the object included in the image data is specified by executing recognition processing of the image data.

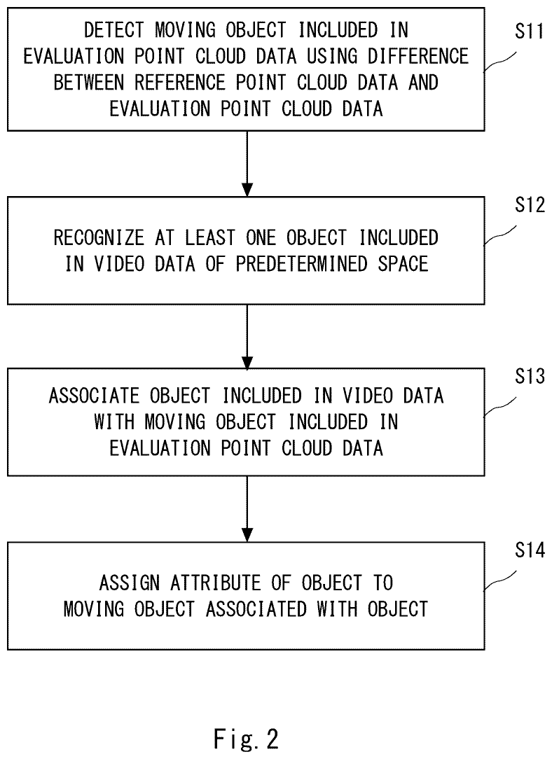

FIG. 2 illustrates a flow of analysis processing executed in the analysis device 10. First, the detection unit 11 detects at least one moving object included in the evaluation point cloud data by using a difference between the reference point cloud data indicating the predetermined space in the reference period and the evaluation point cloud data indicating the predetermined space in the evaluation period (S11). Next, the recognition unit 12 recognizes at least one object included in the image data of the predetermined space (S12). Next, the processing unit 13 associates at least one object with at least one moving object (S13). Next, the attribute assignment unit 14 assigns the attribute of the object to the moving object associated with the object (S14).

As described above, the analysis device 10 can specify the attribute of the moving object included in the point cloud data by using the result of the recognition processing executed on the image data. As a result, the analysis device 10 can avoid the recognition processing using the point cloud data having a large processing load, so that the processing load can be reduced as compared with the case of executing the recognition processing using the point cloud data.

### Second Example Embodiment

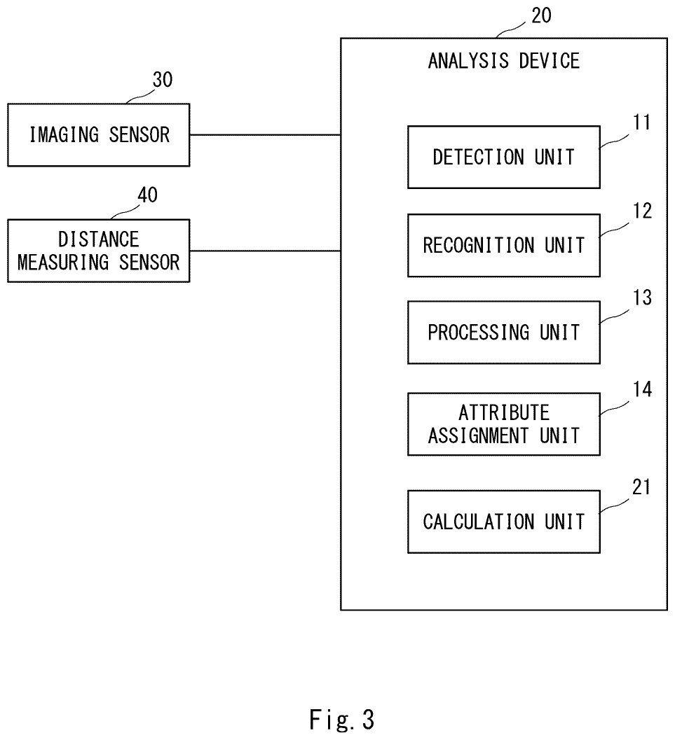

FIG. 3 illustrates a configuration example of an analysis system. The analysis system in FIG. 3 includes an analysis device 20, an imaging sensor 30, and a distance measuring sensor 40. The analysis device 20 corresponds to the analysis device 10 of FIG. 1. In FIG. 3, the imaging sensor 30 and the distance measuring sensor 40 are illustrated as devices different from the analysis device 20, but one or both of the imaging sensor 30 and the distance measuring sensor 40 may be used as a device integrated with the analysis device 20. That is, one or both of the imaging sensor 30 and the distance measuring sensor 40 may be a component of the analysis device 20.

The imaging sensor 30 generates image data of a predetermined space. The imaging sensor 30 may be, for example, a camera that generates image data that is digital data. The image data may be moving image data or still image data. The imaging sensor 30 may periodically transmit the image data to the analysis device 20, or may transmit the image data to the analysis device 20 in response to a request from the analysis device 20.

The distance measuring sensor 40 generates three-dimensional point cloud data of a predetermined space. The distance measuring sensor 40 may be, for example, a LiDAR device. The LiDAR device may be, for example, a device for measuring a distance to an object using a Time of Flight (ToF) method. The distance measuring sensor 40 may generate three-dimensional point cloud data of a space substantially the same as a predetermined space to be a target of the image data generated by the imaging sensor 30. Alternatively, the distance measuring sensor 40 may generate three-dimensional point cloud data of a space including a predetermined space to be a target of the image data generated by the imaging sensor 30. Alternatively, the imaging sensor 30 may generate image data of a space including a predetermined space to be a target of the three-dimensional point cloud data generated by the distance measuring sensor 40. Alternatively, a partial region of the space of the three-dimensional point cloud data generated by the distance measuring sensor 40 and a partial region of the space of the image data generated by the imaging sensor 30 may overlap.

The distance measuring sensor 40 may periodically transmit the three-dimensional point cloud data to the analysis device 20, or may transmit the three-dimensional point cloud data to the analysis device 20 in response to a request from the analysis device 20.

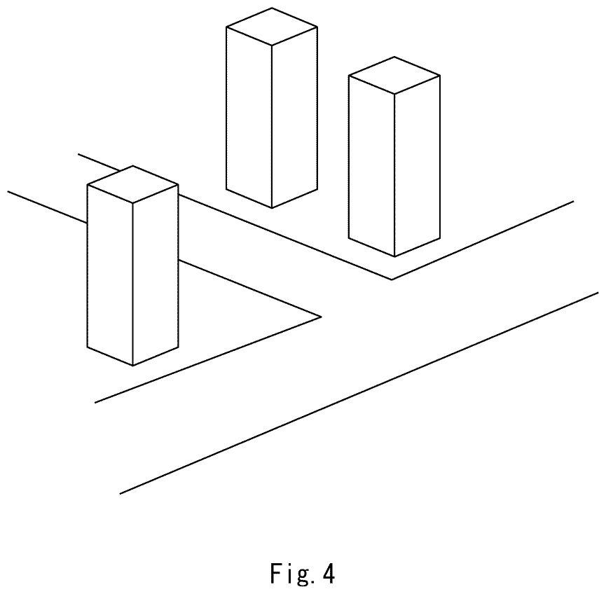

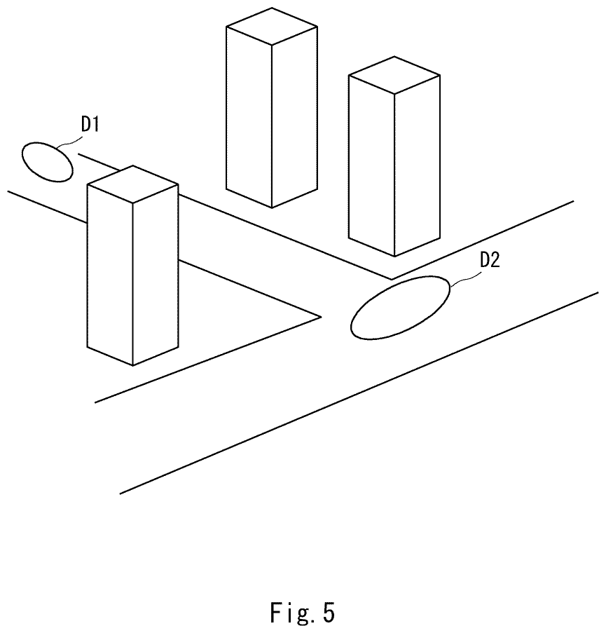

Here, three-dimensional point cloud data generated by the distance measuring sensor 40 will be described with reference to FIGS. 4 and 5. FIG. 4 is three-dimensional point cloud data generated in a reference period. Furthermore, FIG. 5 is three-dimensional point cloud data generated in an evaluation period. The three-dimensional point cloud data of FIG. 4 indicates a space in which a road and a building exist. In the three-dimensional point cloud data of FIG. 5, data D1 and D2 are added to the three-dimensional point cloud data of FIG. 4. Since D1 and D2 are objects that did not exist in the reference period, they are estimated as moving objects.

FIGS. 4 and 5 illustrate the shape of a building or the like, but actually, a point cloud exists on the surface of a building, the surface of a road, or the like. That is, FIGS. 4 and 5 illustrate the outline of the shape indicated by the point cloud.

Each piece of three-dimensional point cloud data is data in which the shape of a building, a road, or the like is clearly indicated as illustrated in FIGS. 4 and 5 by accumulating point clouds measured in a period defined in advance. In addition, since the data D1 and D2 illustrated in FIG. 5 are moving objects, the shape of the object indicated by the point cloud may not be clearly shown. The fact that the shape of the object is not clearly shown may mean that the outline of the object is unclear. Furthermore, for the sake of facilitating the explanation, FIGS. 4 and 5 do not illustrate points that are treated as so-called noise.

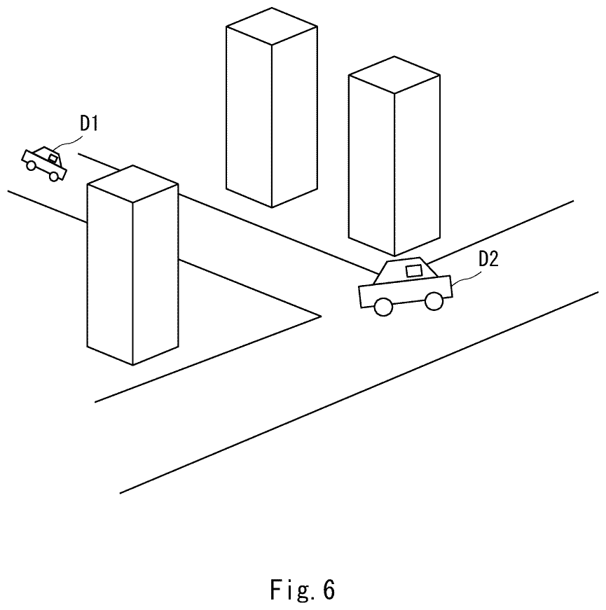

In addition, image data indicating a space substantially the same as the space indicated by the three-dimensional point cloud data generated by the distance measuring sensor 40 also includes objects and the like similar to those in FIGS. 4 and 5. The image data may be, for example, data indicated using RGB (Red, Green, Blue) data. In the image data, for example, the shape of the object may be indicated using a color difference from another object. In addition, as illustrated in FIG. 6, the shape of the moving object is clearly shown in the image data. The fact that the shape of the moving object is clearly shown may mean that the moving object is shown to an extent that the attribute of the moving object can be recognized. FIG. 6 illustrates shapes of the data D1 and D2 to the extent that the data D1 and D2 in FIG. 5 can be recognized as vehicles.

In addition, the distance measuring sensor 40 may generate a plurality of pieces of three-dimensional point cloud data in order to track the moving object during the evaluation period. The plurality of pieces of three-dimensional point cloud data may be three-dimensional point cloud data generated at different timings. For example, it is assumed that the moving object exists at different positions in each piece of three-dimensional point cloud data. Similarly, the imaging sensor 30 may generate the image data at a timing similar to the timing at which the three-dimensional point cloud data is generated. That is, the imaging sensor 30 and the distance measuring sensor 40 may generate three-dimensional point cloud data and image data indicating spaces at substantially the same timing. The imaging sensor 30 and the distance measuring sensor 40 may have, for example, synchronized time information, and may generate image data and three-dimensional point cloud data at timing defined in advance. Alternatively, the imaging sensor 30 and the distance measuring sensor 40 may synchronize timings of generating the image data and the three-dimensional point cloud data by transmitting a message via the analysis device 20 or via a network. Alternatively, the imaging sensor 30 and the distance measuring sensor 40 may generate image data and three-dimensional point cloud data indicating spaces at different timings within a predetermined period.

Returning to FIG. 3, the analysis device 20 has a configuration in which a calculation unit 21 is added to the analysis device 10 of FIG. 1. The calculation unit 21 may be used as a means for calculating a value using data. Detailed description of functions or processing similar to those of the analysis device 10 in the analysis device 20 will be omitted.

The detection unit 11 uses the three-dimensional point cloud data received from the distance measuring sensor 40 in the reference period as reference point cloud data in comparison processing. Furthermore, the detection unit 11 uses the three-dimensional point cloud data received from the distance measuring sensor 40 in the evaluation period as evaluation point cloud data in comparison processing.

For example, the detection unit 11 extracts the data D1 and D2 as the difference data by comparing the reference point cloud data illustrated in FIG. 4 with the evaluation point cloud data illustrated in FIG. 5. For example, the detection unit 11 groups, as the same cluster, a plurality of points at which a distance between points included in the point cloud data extracted as the difference data, for example, a Euclidean distance, is equal to or less than a value defined in advance. The detection unit 11 generates a cluster of the data D1 and a cluster of the data D2 by grouping using the Euclidean distance between the points. A point included in the point cloud data extracted as the difference data may be referred to as a difference point.

That is, at each point included in the data D1 and each point included in the data D2, the Euclidean distance between the adjacent points is equal to or less than a value defined in advance. The value defined in advance may be paraphrased as a predetermined value, a threshold value, or the like.

Alternatively, the detection unit 11 may group, as the same cluster, a plurality of points at which a difference in distance from the distance measuring sensor 40 of each point included in the point cloud data extracted as the difference data is equal to or less than a value defined in advance.

Alternatively, the detection unit 11 may further divide the cluster defined based on the Euclidean distance between the points into a plurality of clusters based on the distance from the distance measuring sensor 40. Alternatively, the detection unit 11 may further divide the cluster defined based on the distance from the distance measuring sensor 40 into a plurality of clusters based on the Euclidean distance between the points.

Furthermore, the detection unit 11 sets a bounding box including the data D1 and a bounding box including the data D2. The bounding box may be rephrased as a cube. The bounding box is, for example, a rectangular parallelepiped, and the bounding box includes all the point clouds of the data D1 or D2.

For example, the detection unit 11 may set the first component specified by performing the principal component analysis on the point cloud included in the data D1 as the length of the long side of the bounding box. Furthermore, the detection unit 11 may set at least one component in a direction orthogonal to the first component as the length of the short side of the bounding box. The short side is a side shorter than the long side. In a case where there are a plurality of short sides, the lengths of each of the short sides may be different.

Furthermore, the detection unit 11 may determine the size and position of the bounding box in such a way as to include all the point clouds of the data D1 and D2 by specifying the center of the data D1.

The recognition unit 12 executes image recognition processing on image data generated at substantially the same timing as the timing at which the data D2 is generated. The recognition unit 12 specifies the attribute of the object included in the image data by executing the image recognition processing. For example, the recognition unit 12 may specify or extract a vehicle or a person included in the image data as an attribute. Furthermore, the recognition unit 12 sets a bounding box in such a way as to surround the specified or extracted object. The bounding box set in the image data has a two-dimensional shape, and may be, for example, a rectangle, a square, or the like.

The processing unit 13 projects the respective bounding boxes of the data D1 and D2 onto the image data. For example, the processing unit 13 projects a bounding box onto image data generated at substantially the same timing as the timing at which the three-dimensional point cloud data including the data D1 and D2 is generated. The three-dimensional point cloud data and the image data indicate substantially the same space. Therefore, projecting may be projecting a bounding box that is three-dimensional data as two-dimensional data to a position in the image data corresponding to a position of the bounding box in the three-dimensional point cloud data.

In a case where the projected bounding boxes of the data D1 and D2 overlap with the bounding box in the image data, the processing unit 13 associates the data D1 and D2 with the object in the image data as a pair. Overlapping may mean that a partial region or the entire region of the projected bounding box is included in the bounding box in the image data. Alternatively, overlapping may mean that a region of X percent (X is a positive number) of the projected bounding box is included in the bounding box in the image data. The value of X percent may be defined in advance.

Alternatively, in a case where the difference between the size of the projected bounding box and the size of the bounding box in the image data is within a predetermined range, the processing unit 13 may associate objects included in each bounding box as a pair. That is, even in a case where the projected bounding box does not overlap the bounding box in the image data, the processing unit 13 may determine an object to be paired based on the size of each bounding box.

The attribute assignment unit 14 assigns an attribute to the three-dimensional point cloud data associated as a pair with the object of which the attribute is specified in the image recognition processing. For example, the attribute assignment unit 14 assigns a truck attribute to a cluster of three-dimensional point cloud data associated as a pair with an object specified as a truck. As a result, the attribute of the moving object included in the three-dimensional point cloud data is determined.

The calculation unit 21 calculates the speed of the cluster of which the attribute is determined. For example, the calculation unit 21 calculates the speed of the bounding box by using the movement amount per predetermined time of the center of the bounding box set in the cluster. Alternatively, the calculation unit 21 calculates the speed of the bounding box by using the movement amount per predetermined time at an arbitrary position in the bounding box set in the cluster. The speed of the bounding box corresponds to the speed of the object included in the bounding box. The movement amount per predetermined time at an arbitrary position in the bounding box may be referred to as, for example, displacement per predetermined time of an arbitrary point in the bounding box. In a case where the movement amount is to be calculated, the calculation unit 21 uses a plurality of pieces of three-dimensional point cloud data generated at different timings.

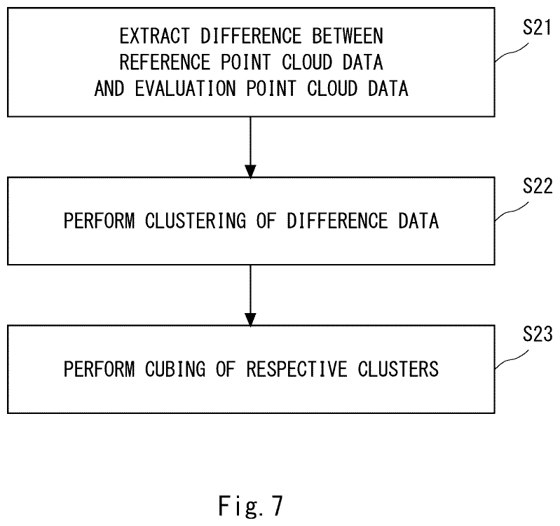

Next, a flow of processing related to three-dimensional point cloud data will be described. FIG. 7 illustrates a flow of processing related to three-dimensional point cloud data executed by the analysis device 20.

First, the detection unit 11 extracts a difference between the three-dimensional point cloud data received from the distance measuring sensor 40 in the reference period and the three-dimensional point cloud data received from the distance measuring sensor 40 in the evaluation period (S21).

Next, the detection unit 11 groups, as the same cluster, a plurality of points at which the Euclidean distance between the points included in the three-dimensional point cloud data extracted as the difference data is equal to or less than a value defined in advance (S22).

Next, the detection unit 11 cubes each cluster (S23). Cubing may be setting bounding boxes for each cluster.

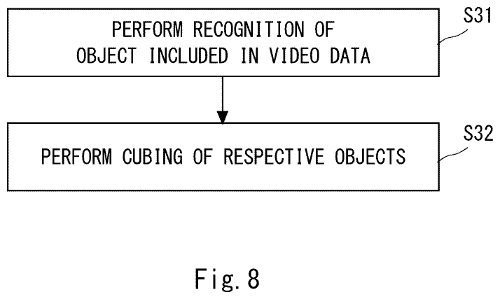

Next, a flow of processing related to image data will be described. FIG. 8 illustrates a flow of processing related to image data executed in the analysis device 20.

First, the recognition unit 12 performs recognition of an object included in the image data (S31). Specifically, the recognition unit 12 executes image recognition processing on the image data. The recognition unit 12 specifies the attribute of the object included in the image data by executing the image recognition processing.

Next, the recognition unit 12 performs cubing related to the object included in the image data (S32). Specifically, the recognition unit 12 sets a bounding box in such a way as to surround the object included in the image data.

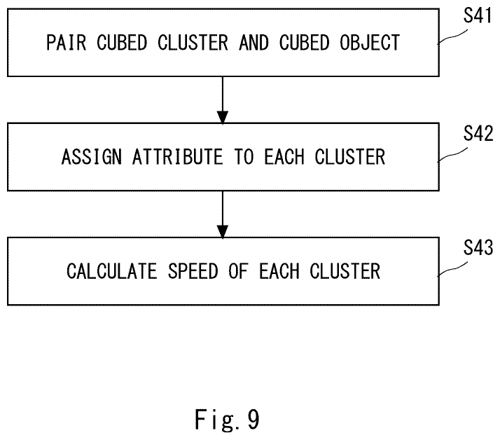

Next, processing using the three-dimensional point cloud data and the image data will be described. FIG. 9 illustrates calculation processing of the speed of the object executed in the analysis device 20.

First, the processing unit 13 pairs a cubed cluster of the three-dimensional point cloud data and a cubed object in the image data (S41). Pairing may be paraphrased as associating. Specifically, the processing unit 13 may execute pairing according to an overlapping degree of a region obtained by projecting a cubed cluster of the three-dimensional point cloud data onto image data and a region of a cubed object in the image data. The overlapping degree may be, for example, a value indicating how many percent of regions of a cluster is overlapping in a case where the cubed cluster is projected onto the image data. Alternatively, the overlapping degree may be a value indicating how many percent of regions of the cubed objects is overlapping in the image data. The processing unit 13 may determine that the cluster of the three-dimensional point cloud data corresponds to the object in the image data in a case where the overlapping degree is greater than a value defined in advance.

Next, the attribute assignment unit 14 assigns the attribute specified for the object in the image data to the cluster of the three-dimensional point cloud data associated with the object in the image data (S42).

Next, the calculation unit 21 calculates the speed of each cluster included in the three-dimensional point cloud data (S43). For example, the calculation unit 21 may calculate the speed of the bounding box by using the movement amount per predetermined time of the center of the bounding box set in the cluster. In addition, the calculation unit 21 may calculate the speed of only the cluster to which the attribute with vehicle is assigned, or may calculate the speed of only the cluster to which the attribute with the vehicle or person is assigned. Alternatively, the calculation unit 21 may calculate the speed of only a cluster to which an attribute defined in advance as a moving object is assigned.

As described above, the analysis device 20 can apply the result of the recognition processing related to the image data to the cluster included in the three-dimensional point cloud data by associating the cluster included in the three-dimensional point cloud data with the object in the image data. That is, the analysis device 20 assigns the attribute of the object obtained by executing the image recognition processing of the image data to the cluster of the three-dimensional point cloud data associated with the object. As a result, the analysis device 20 can avoid the image recognition processing regarding the three-dimensional point cloud data having a high processing load.

Furthermore, the analysis device 20 calculates the moving speed of the cluster moving through the three-dimensional space. As a result, the analysis device 20 can calculate a highly accurate moving speed as compared with the calculation result of the moving speed using the object included in the image data in which the depth cannot be measured.

### Third Example Embodiment

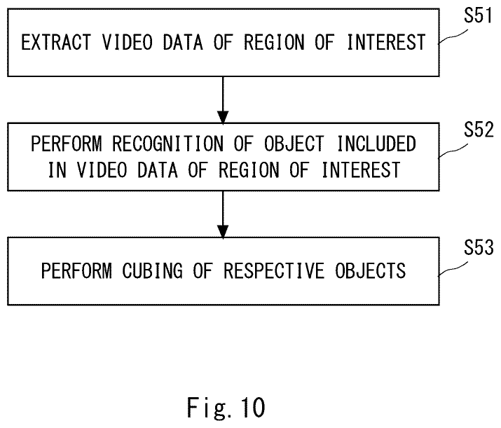

FIG. 10 illustrates a flow of image recognition processing of image data regarding a region of interest. The image data regarding the region of interest may be determined using, for example, difference data between the reference point cloud data and the evaluation point cloud data.

For example, the region of interest may be a region of a cubed cluster projected onto the image data by the processing unit 13. The projection of the cubed cluster onto the image data is similar to the processing executed in step S41 of FIG. 9. Alternatively, the region of interest may be a region including a region of a cluster projected onto the image data and a peripheral region of the region of the cluster. The peripheral region may be, for example, a region having a place distant from the boundary of the cluster by Y meters (Y is a positive value) as a boundary. In a case where there are a plurality of cubed clusters, there are also a plurality of regions of interest. The region of interest may be referred to as a partial region included in the image data.

The recognition unit 12 extracts the region of the cubed cluster projected onto the image data by the processing unit 13 or the region including the peripheral region of the cubed cluster as the region of interest (S51).

Next, the recognition unit 12 performs recognition of an object included in the image data of the region of interest (S52). The image data of the region of interest is a part of the image data, and thus may be referred to as partial image data. In a case where there are a plurality of regions of interest, the recognition unit 12 performs recognition of an object for each region of interest. Next, the recognition unit 12 cubes each object whose attribute has been specified (S53).

As described above, the recognition unit 12 uses the data of the region of interest included in the image data as the image data used for the image recognition processing. For example, the image recognition processing is executed using software for image recognition processing. The software for the image recognition processing may be referred to as a video recognition engine or the like. It is assumed that an appropriate value of the resolution or the image size of the image input to the software for image recognition processing is defined in advance. Here, by using the region of interest for the image recognition processing, the image size of the image data used for the image recognition processing is reduced, so that the resolution can be increased. As a result, the recognition unit 12 can execute the image recognition processing using the high-resolution image data as compared with the case of using the entire image data including the plurality of regions of interest. For example, even in a case where the image recognition processing is usually performed with the resolution of the image data generated by the imaging sensor 30 lowered, the recognition unit 12 can use the high-resolution image data for the image recognition processing by using the image data of the region of interest having a small image size. The high-resolution image data may be, for example, resolution of original image data generated by the imaging sensor 30. As a result, the recognition unit 12 can improve the recognition accuracy of the object in the image recognition processing.

### Fourth Example Embodiment

Next, an example related to clustering processing different from other example embodiments will be described. In FIG. 7, it has been described that the detection unit 11 extracts the difference between the reference point cloud data and the evaluation point cloud data. Here, the distance measuring sensor 40 generates point cloud data by irradiating a specific range with a beam. Therefore, as the position becomes farther away from the distance measuring sensor 40, the number of points in the point cloud data indicating the object decreases. That is, the distance between the points in the point cloud data indicating the object increases. Due to the increase in distance between the points, point cloud data for an object smaller in size than the distance between the points may not be shown.

In order to solve such a problem, for example, the distance measuring sensor 40 may generate the reference point cloud data and the evaluation point cloud data by increasing a time for accumulating points as a distance from the distance measuring sensor 40 increases. The number of points accumulated as the evaluation point cloud data increases by lengthening the time for accumulating points. As the time for accumulating points becomes longer, the probability that the beam is reflected even by an object having a small size can be improved, so that the point cloud data of the object having the small size can also be generated without omission.

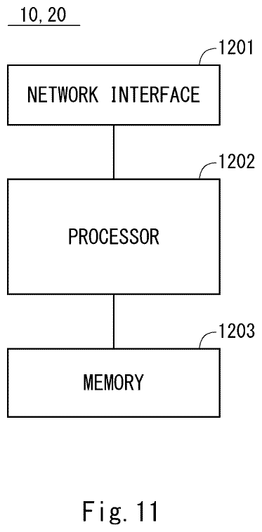

FIG. 11 is a block diagram illustrating a configuration example of the analysis devices 10 and 20 (hereinafter referred to as the analysis device 10 and the like). Referring to FIG. 11, the analysis device 10 and the like include a network interface 1201, a processor 1202, and a memory 1203. The network interface 1201 may be used to communicate with network nodes. The network interface 1201 may include, for example, a network interface card (NIC) conforming to IEEE 802.3 series. The IEEE represents the Institute of Electrical and Electronics Engineers.

The processor 1202 executes the processing in the analysis device 10 and the like described using the flowcharts, by reading software (computer programs) from the memory 1203 and executing the software. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 via an Input/Output (I/O) interface (not illustrated).

In the example in FIG. 11, the memory 1203 is used to store a group of software modules. The processor 1202 can perform the processing in the analysis device 10 and the like by reading the software module group from the memory 1203 and executing the software module group.

As described with reference to FIG. 11, each of the processors included in the analysis device 10 and the like executes one or a plurality of programs including a command group for causing a computer to perform the algorithm described with reference to the drawings.

In the example described above, the program includes a group of commands (or software codes) for causing a computer to execute one or more functions described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or another memory technology, a CD-ROM, a digital versatile disc (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. By way of example, and not limitation, a transitory computer-readable medium or communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All the features or steps illustrated in any one of the figures for describing illustrative example embodiments are not necessarily mandatory, and some features or steps may be omitted. The order of the steps described in any of the figures may be changed as appropriate.

Some or all the example embodiments described above may be described as, but are not limited to, the following Supplementary Notes.

### (Supplementary Note 1)

An analysis device including:
a detection unit for detecting at least one moving object included in evaluation point cloud data by using a difference between reference point cloud data indicating a predetermined space in a reference period and the evaluation point cloud data indicating the predetermined space in an evaluation period,
a recognition unit for recognizing at least one object included in image data of the predetermined space,
a processing unit for associating the at least one object with the at least one moving object, and
an attribute assignment unit for assigning an attribute of the object to the moving object associated with the object.

### (Supplementary Note 2)

The analysis device according to supplementary note 1, in which the processing unit associates the object and the moving object based on a size of a region where a region indicating the object included in the image data and a region indicating the moving object included in the evaluation point cloud data overlap with each other.

### (Supplementary Note 3)

The analysis device according to supplementary note 1 or 2, in which the detection unit detects, as the moving object, a set of first difference points at which a distance between a plurality of difference points is equal to or less than a threshold value among the difference points included in difference data between the reference point cloud data and the evaluation point cloud data.

### (Supplementary Note 4)

The analysis device according to any one of supplementary notes 1 to 3, in which the recognition unit recognizes the object included in partial image data by using the partial image data indicating a partial region corresponding to a region indicating the moving object included in the evaluation point cloud data in the image data.

### (Supplementary Note 5)

The analysis device according to any one of supplementary notes 1 to 4, in which the detection unit increases number of points to be accumulated as the evaluation point cloud data as a distance from a sensor for generating the evaluation point cloud data increases.

### (Supplementary Note 6)

The analysis device according to any one of supplementary notes 1 to 5, further including a calculation unit for calculating a moving speed of the moving object by using displacement of coordinates of a first point included in a plurality of points indicating the moving object.

### (Supplementary Note 7)

The analysis device according to supplementary note 6, in which the calculation unit calculates the moving speed of the moving object by using displacement of coordinates of a center of a solid including the plurality of points indicating the moving object.

### (Supplementary Note 8)

An analysis system including:
a first sensor for generating reference point cloud data indicating a predetermined space in a reference period and evaluation point cloud data indicating the predetermined space in an evaluation period,
a second sensor for generating image data of the predetermined space, and
an analysis device including a detection unit for detecting at least one moving object included in the evaluation point cloud data by using a difference between the reference point cloud data and the evaluation point cloud data, a recognition unit for recognizing at least one object included in the image data of the predetermined space, a processing unit for associating the at least one object with the at least one moving object; and an attribute assignment unit for assigning an attribute of the object to the moving object associated with the object.

### (Supplementary Note 9)

An analysis method including:
detecting at least one moving object included in evaluation point cloud data by using a difference between reference point cloud data indicating a predetermined space in a reference period and the evaluation point cloud data indicating the predetermined space in an evaluation period,
recognizing at least one object included in image data of the predetermined space,
associating the at least one object with the at least one moving object, and
assigning an attribute of the object to the moving object associated with the object.

### (Supplementary Note 10)

A program for causing a computer to execute:
detecting at least one moving object included in evaluation point cloud data by using a difference between reference point cloud data indicating a predetermined space in a reference period and the evaluation point cloud data indicating the predetermined space in an evaluation period,
recognizing at least one object included in image data of the predetermined space,
associating the at least one object with the at least one moving object, and
assigning an attribute of the object to the moving object associated with the object.

Some or all the elements (e.g., configurations and functions) described in Supplementary Notes 2 to 7 dependent on Supplementary Note 1 may also be dependent on Supplementary Notes 8 to 10 due to the same dependency relationship as Supplementary Notes 2 to 7. Some or all the elements described in any Supplementary Note may be applied to various types of hardware, software, recording means for recording software, systems, and methods.

1. An analysis device comprising:
at least one memory storing instructions; and
at least one processor configured to execute the instructions to:
detect at least one moving object included in evaluation point cloud data by using a difference between reference point cloud data indicating a predetermined space in a reference period and the evaluation point cloud data indicating the predetermined space in an evaluation period;
recognize at least one object included in image data of the predetermined space;
associate the at least one object with the at least one moving object; and
assign an attribute of the object to the moving object associated with the object.

2. The analysis device according to claim 1, wherein the at least one processor of the first base station is further configured to execute the instructions to associate the object and the moving object based on a size of a region where a region indicating the object included in the image data and a region indicating the moving object included in the evaluation point cloud data overlap with each other.

3. The analysis device according to claim 1, wherein the at least one processor of the first base station is further configured to execute the instructions to detect, as the moving object, a set of first difference points at which a distance between a plurality of difference points is equal to or less than a threshold value among the difference points included in difference data between the reference point cloud data and the evaluation point cloud data.

4. The analysis device according to claim 1, wherein the at least one processor of the first base station is further configured to execute the instructions to recognize the object included in partial image data by using the partial image data indicating a partial region corresponding to a region indicating the moving object included in the evaluation point cloud data in the image data.

5. The analysis device according to claim 1, wherein the at least one processor of the first base station is further configured to execute the instructions to increase number of points to be accumulated as the evaluation point cloud data as a distance from a sensor for generating the evaluation point cloud data increases.

6. The analysis device according to claim 1, wherein the at least one processor of the first base station is further configured to execute the instructions to calculate a moving speed of the moving object by using displacement of coordinates of a first point included in a plurality of points indicating the moving object.

7. The analysis device according to claim 6, wherein the at least one processor of the first base station is further configured to execute the instructions to calculate the moving speed of the moving object by using displacement of coordinates of a center of a solid including the plurality of points indicating the moving object.

8. An analysis method comprising:
detecting at least one moving object included in evaluation point cloud data by using a difference between reference point cloud data indicating a predetermined space in a reference period and the evaluation point cloud data indicating the predetermined space in an evaluation period;
recognizing at least one object included in image data of the predetermined space;
associating the at least one object with the at least one moving object; and
assigning an attribute of the object to the moving object associated with the object.

9. A non-transitory computer-readable medium storing a program for causing a computer to execute:
detecting at least one moving object included in evaluation point cloud data by using a difference between reference point cloud data indicating a predetermined space in a reference period and the evaluation point cloud data indicating the predetermined space in an evaluation period;
recognizing at least one object included in image data of the predetermined space;
associating the at least one object with the at least one moving object; and
assigning an attribute of the object to the moving object associated with the object.
